(19) United States
(12) Patent Application Publication
(10) Pub. No.: US 2023/0224526 A1
(43) Pub. Date: Jul. 13, 2023

(54) PROCESSING OF MULTIMEDIA CONTENT ON AN EDGE DEVICE

(71) Applicant: Myelin Foundry Private Limited, Bengaluru (IN)

(72) Inventors: Ganesh Suryanarayanan, Bangalore (IN); Vishvanath Deshpande, Bangalore (IN); Anusha Rammohan, Bangalore (IN); Vasant Jain, Bangalore (IN)

(21) Appl. No.: 18/000,934

(22) PCT Filed: Nov. 10, 2020
(86) PCT No.: PCT/IN2020/050947

§ 371 Date: Dec. 7, 2022

(30) Foreign Application Priority Data
Jun. 8, 2020 (IN) 202041023911

(51) Int. Cl. H04N 21/25; H04N 21/258

(52) U.S. Cl. CPC H04N 21/251; H04N 21/25866

(57) ABSTRACT

A system (100) for context driven processing of multimedia content (402) on an edge device (104) is presented. The system (100) includes an acquisition subsystem (404). Furthermore, the system (100) includes a processing subsystem (406) that includes a context aware artificial intelligence platform (408) configured to generate context characteristics based on user characteristics, edge device characteristics, and multimedia characteristics, retrieve a model (324, 412) based on the context characteristics, identify processing steps based on the model (324, 412), the context characteristics, or both, where the processing steps are used to perform context driven processing of input multimedia content (402) on the edge device (104), select, based on the model (324, 412), the context characteristics, or both, one or more target processing units (100) to perform the processing steps, and execute the processing steps on the selected target processing units (418, 420, 422, 424, 426) to generate improved output multimedia content. The system (100) includes an interface unit (428, 430) configured to provide, on the edge device (104), the improved output multimedia content.

### CROSS REFERENCE TO RELATED APPLICATION

This patent application claims priority from the Indian Provisional Patent Application Serial No. 202041023911, filed Jun. 8, 2020, titled “REAL-TIME PROCESSING OF MULTIMEDIA DATA ON AN EDGE DEVICE” the entire disclosure of which is incorporated herein by reference.

### BACKGROUND

Embodiments of the present specification relate generally to processing of multimedia content, and more particularly to systems and methods for context driven processing of multimedia content on an edge device.

Rapid advances in broadband internet, cloud computing, networking, and the like have led to an exponential increase in the demand for the real-time streaming of multimedia content. More recently, there has been an increased demand for streaming multimedia content on an edge device such as a smart phone, a television, a router, and the like. However, the huge footprint of the multimedia content disadvantageously results in substantially high costs associated with storage and/or transmission of the multimedia content. Additionally, insufficient bandwidth adversely impacts the streaming of the multimedia content, thereby resulting in buffering, long load times, pixellation, poor quality of viewer experience, and the like. Consequently, quality of an end user's viewing experience may be undesirably impacted as the limited bandwidth and/or the high streaming costs restrict the amount of information that can be streamed to the end user. Furthermore, some edge devices may not be capable of streaming certain types of multimedia content.

Certain presently available techniques for addressing the issues with variations in the availability of the bandwidth entail compressing the multimedia content for both storage and streaming. Also, some other video streaming techniques tackle the challenges of bandwidth variability by creating and storing multiple versions of the same video at varying resolutions and bitrates and/or by transcoding a video in real-time at varying bitrates depending on the bandwidth available. However, these techniques disadvantageously result in higher transcoding, storage, and/or transmission costs.

Moreover, in recent times, there have been attempts to use machine learning techniques to address issues with video streaming. However, these techniques are restricted to larger cloud-based and/or desktop-class compute resources and hence fail to achieve real-time video streaming performance on resource-constrained edge devices. Additionally, performance metrics associated with the currently available techniques are generally targeted to sets of well-researched, limited, competition-focused data. Hence, these techniques fail to scale to real-world video streaming datasets, which have larger range of features, parameters, and/or deviations.

Furthermore, use of contextual information in the content streamed to any particular user to enhance the quality of a user's experience has not been explored heretofore, thereby limiting streaming service providers' quality of offerings as well as end users' quality of experience all, while increasing operational costs.

### BRIEF DESCRIPTION

In accordance with aspects of the present specification, a system for context driven processing of multimedia content on an edge device is presented. The system includes an acquisition subsystem configured to obtain input multimedia content. Furthermore, the system includes a processing subsystem in operative association with the acquisition subsystem and including a context aware artificial intelligence platform, where the context aware artificial intelligence platform is, on the edge device, configured to generate context characteristics based on user characteristics, edge device characteristics, multimedia characteristics, or combinations thereof, retrieve at least one model based on the context characteristics, identify one or more processing steps based on the at least one model, the context characteristics, or both the at least one model and the context characteristics, where the one or more processing steps are used to perform context driven processing of the input multimedia content on the edge device, select, based on the at least one model, the context characteristics, or both the at least one model and the context characteristics, one or more target processing units to perform the one or more processing steps, and execute the one or more processing steps on the selected one or more target processing units to generate improved output multimedia content, where the improved output multimedia content comprises enhanced visual quality, enhanced aural quality, enhanced information content, or combinations thereof. In addition, the system includes an interface unit configured to provide, on the edge device, the improved output multimedia content.

In accordance with another aspect of the present specification, a method for context driven processing of multimedia content on an edge device is presented. The method includes (a) receiving multimedia content, (b) generating context characteristics based on user characteristics, edge device characteristics, multimedia characteristics, or combinations thereof, (c) retrieving at least one model based on the context characteristics, (d) identifying one or more processing steps based on the at least one model, the context characteristics, or both the at least one model and the context characteristics, wherein the one or more processing steps are used to perform context driven processing of the input multimedia content on the edge device, (e) selecting, based on the at least one model, the context characteristics, or both the at least one model and the context characteristics, one or more target processing units to perform the one or more processing steps, (f) executing the one or more processing steps on the selected one or more target processing units to generate improved output multimedia content, wherein the improved output multimedia content comprises enhanced visual quality, enhanced aural quality, enhanced information content, or combinations thereof, and (g) providing the improved output multimedia content. Moreover, a non-transitory computer readable medium that stores instructions executable by one or more processors to perform the method for context driven processing of multimedia content on an edge device is also presented.

In accordance with yet another aspect of the present specification, a processing system for context driven processing of multimedia content on an edge device is presented. The processing system includes a context aware artificial intelligence platform, wherein the context aware artificial intelligence platform is, in real-time on the edge device, configured to generate context characteristics based on user characteristics, edge device characteristics, multimedia characteristics, or combinations thereof, retrieve at least one model based on the context characteristics, identify one or more processing steps based on the at least one model, the context characteristics, or both the at least one model and the context characteristics, wherein the one or more processing steps are used to perform context driven processing of the input multimedia content on the edge device, select, based on the at least one model, the context characteristics, or both the at least one model and the context characteristics, one or more target processing units to perform the one or more processing steps, execute the one or more processing steps on the selected one or more target processing units to generate improved output multimedia content, wherein the improved output multimedia content comprises enhanced visual quality, enhanced aural quality, enhanced information content, or combinations thereof, and provide the improved output multimedia content, wherein the context aware processing of the multimedia content in performed real-time, on the edge device.

### DRAWINGS

These and other features and aspects of embodiments of the present specification will become better understood when the following detailed description in read with reference to the accompanying drawings in which like characters represent like parts throughout the drawings, wherein:

FIG. 1 is a schematic representation of an exemplary system for context driven processing of multimedia content on an edge device, in accordance with aspects of the present specification;

FIG. 2 is a flow chart illustrating a method for context driven processing of multimedia content on an edge device, in accordance with aspects of the present specification;

FIG. 3 is a flow chart illustrating a method for generating one or more models for use in the method for context driven processing of multimedia content on an edge device of FIG. 2, in accordance with aspects of the present specification;

FIG. 4 is a schematic representation of one embodiment of a context driven multimedia processing system for use in the system of FIG. 1, in accordance with aspects of the present specification; and

FIG. 5 is a schematic representation of one embodiment of a digital processing system implementing a context driven multimedia processing system for use in the system of FIG. 1, in accordance with aspects of the present specification.

### DETAILED DESCRIPTION

The following description presents exemplary systems and methods for context driven processing of multimedia content on an edge device. In certain embodiments, the exemplary systems and methods facilitate context driven processing of multimedia content in real-time on an edge device. Embodiments described hereinafter present exemplary systems and methods that facilitate enhanced quality of experience for a user of an edge device and/or a viewer of streamed multimedia content on an edge device in real-time and independent of network bandwidths constraints. Moreover, these systems and methods provide a solution that is agnostic of the currently available infrastructure and aids in reducing streaming costs. Use of the present systems and methods presents advantages in reliably providing significant enhancement in the quality of experience for end consumers and reducing transcoding, storage, and/or transmission costs for streaming service providers, thereby overcoming the drawbacks of currently available methods of enhancing quality of streamed multimedia content.

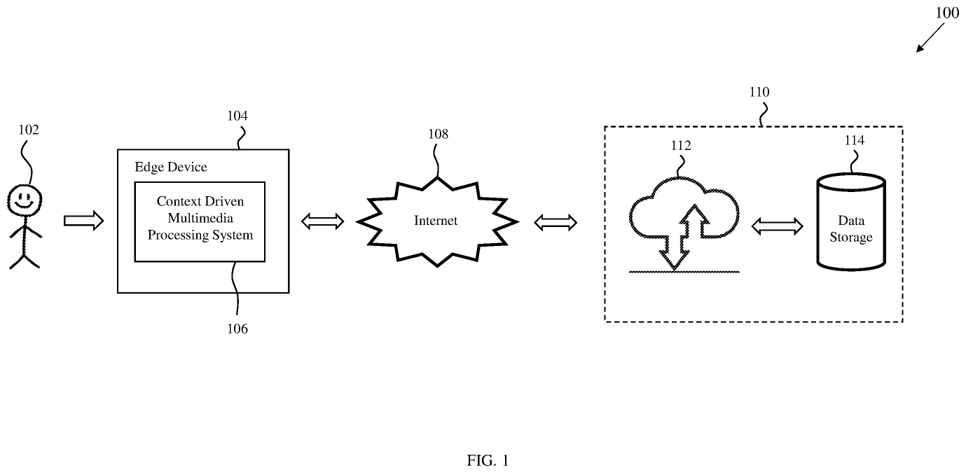

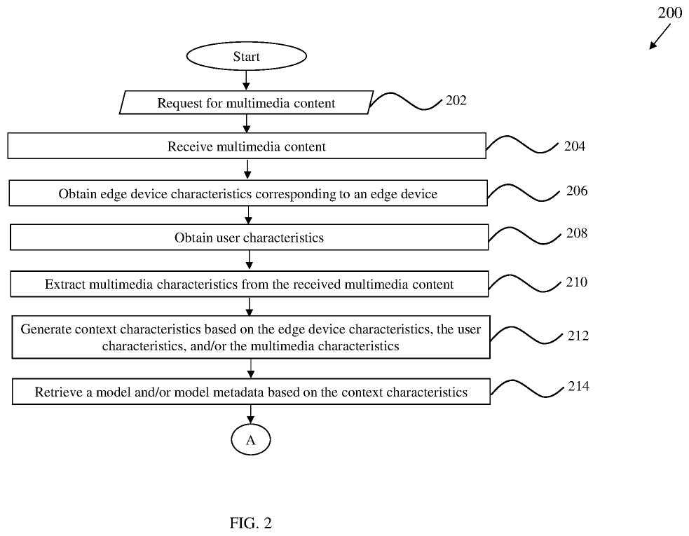

For ease of understanding, the exemplary embodiments of the present systems and methods are described in the context of streaming multimedia. However, use of the exemplary embodiments illustrated hereinafter in other systems and applications such as multimedia storage, transmission, consumption, and multiplexed communication is also contemplated. An exemplary environment that is suitable for practising various implementations of the present systems and methods is discussed in the following sections with reference to FIG. 1.

As used herein, the term “user” refers to a person using an edge device or the system of FIG. 1 for streaming multimedia content. For example, the user uses an edge device for viewing the streaming multimedia content. The terms “user,” “viewer,” “consumer,” “end user,” and “end consumer” may be used interchangeably.

Also, as used herein, the term “edge device” refers to a device that is a part of a distributed computing topology in which information processing is performed close to where things and/or people produce or consume information. Some non-limiting examples of the edge device include a mobile phone, a tablet, a laptop, a smart television (TV), and the like. Additionally, the term “edge device” may also be used to encompass a device that is operatively coupled to an edge device noted hereinabove. Some non-limiting examples of such a device include a streaming media player that is connected to a viewing device such as a TV and allows a user to stream video and/or music, a gaming device/console, and the like. Other examples of the edge device also include networking devices such as a router, a modem, and the like.

Further, as used herein, the term “multimedia” or “multimedia data” or “multimedia content” encompasses one or more types of data such as, but not limited to, video data, audio data, movies, games, TV shows, images, text, graphic objects, animation sequences, and the like. It may be noted that the terms “multimedia,” “multimedia data,” and “multimedia content” may be used interchangeably.

Also, as used herein, the term “context” or “contextual information” refers to edge device characteristics, user characteristics, multimedia characteristics, or combinations thereof. Furthermore, as used herein, the term “edge device characteristics” refers to characteristics associated with an edge device. Some non-limiting examples of the edge device characteristics include processors of the edge device, processing speed of the processors, processing power, capability to handle specific types of operations, accuracy of output, efficiency of specific operations, and the like. In a similar fashion, the term “user characteristics” refers to characteristics associated with a user of an edge device. Some non-limiting examples of the user characteristics include user preferences, user's usage statistics, user location, user network capabilities, current user environment, and the like. Moreover, as used herein, the term “multimedia characteristics” refers to characteristics associated with the multimedia content. Some non-limiting examples of the multimedia characteristics include a type of the multimedia content such as a video, a genre of the multimedia content, temporal variability, spatial variability, special features, presence of specific subjects such as humans, animals, buildings, and the like.

In addition, as used herein, the term “context driven” processing or “context aware” processing refers to processing of multimedia content based on the context or contextual information. Additionally, as used herein, the term “content aware” extraction refers to processing of multimedia characteristics in the context characteristics based on the multimedia content. Also, as used herein, the term “edge device aware” processing refers to processing of edge device characteristics based on the edge device.

Moreover, as used herein, the term “model” generally refers to a machine learning model. One non-limiting example of a machine learning model is a neural network associated with a specific architecture of interconnected nodes and layers. In one example, the model may be generated as a learnt output by running a machine learning algorithm on training data. The model is trained to recognize certain patterns in data. Once trained, the model may be used to process new input data and perform tasks or jobs. It may be noted that the terms “machine learning model,” “model,” “neural network,” “artificial neural network,” and “neural network model” may be used interchangeably.

Further, as used herein, the term “task” or “job” performed by the model may include super-resolution of input multimedia content to enhance the quality of the input multimedia content, object detection, object segmentation, video and/or audio upscaling, multimedia classification, dynamic range enhancement, noise removal, artifact removal, quality enhancement, information content enhancement, and the like.

Additionally, as used herein, the term “model metadata” refers to information that has been learnt by a model through a process of model training By way of a non-limiting example, in the context of video enhancement, the model metadata learnt after training may represent information loss between a low quality input and a desired high quality output.

Furthermore, as used herein, the term “real-time” is used to refer to imperceptible delays in user experience of multimedia content. By way of example, “real-time” processing entails a minimum continuous processing of at least 25 frames per second of video and aural content. The real-time processing is typically dependent upon the application. Further, the term “real-time” processing may also be used to encompass “near real-time” processing. Also, as used herein, the term “low power” is used to refer to less than 1% additional power consumed by an edge device performing context driven processing of multimedia content when compared to a baseline power consumption (i.e., if context driven processing of multimedia content is not being performed).

Also, as used herein, the term “resolution” refers to the number of pixels that can be displayed in each dimension of a given frame. The resolution is represented in pixels and is typically presented as width×height. Moreover, as used herein, the term “super-resolution” refers to a process of quality enhancement via upscaling and/or enhancing details within an image or a sequence of images. For example, a low resolution image is upscaled to generate an output image having a higher resolution. The “super-resolution” or “higher resolution” multimedia content offers a high pixel density and consequently more details. The higher resolution multimedia content finds application in computer vision applications, pattern recognition, medical imaging. surveillance, forensic and satellite imaging applications, and the like.

Referring now to the drawings, FIG. 1 illustrates an exemplary system 100 for context driven processing of multimedia content on an edge device. In particular, the system 100 is configured to enhance quality of experience for a user or viewer of streaming multimedia content on an edge device and independent of network bandwidths constraints, thereby reducing streaming costs. In some embodiments, the system 100 is configured to perform context driven processing of multimedia content on an edge device in real-time.

In accordance with aspects of the present specification, the system 100 is configured to receive input multimedia content. Further, the system 100 is configured to identify a suitable model for processing the input multimedia content. In particular, the system 100 is configured to identify the suitable model based on context characteristics. Additionally, the system 100 is configured to process the input multimedia content based on the identified model to generate improved or augmented output multimedia content. Moreover, the system 100 is configured to render a display based on the augmented output multimedia content.

It may be noted that the following description is presented with reference to multimedia content including video data. However, the present systems and methods may also find application in processing other multimedia content such as audio data, images, graphics, text, games, graphic objects, animation sequences, and the like. Moreover, the following description of the context driven processing of input multimedia content is presented with reference to an application or task that includes super-resolution of input multimedia content. However, the context driven processing may also be used in other applications or tasks such as, but not limited to, dynamic range enhancement, noise removal, artifact removal, object detection and segmentation, quality enhancement, information content enhancement such as advertisements, and the like.

As depicted in FIG. 1, a user 102 may make a request for multimedia content. In one example, the user 102 may make a request to view streaming multimedia content on an edge device 104. As previously noted, the edge device 104 may be a mobile phone, a smart TV, a tablet, a laptop, a streaming media player, a gaming device/console, a router, a modem, and the like. Further, the edge device 104 may detect the request from the user 102. In one embodiment, an application layer in the edge device 104 may detect the request for streaming multimedia content. In response to the request, the edge device 104 may retrieve the requested input multimedia content from a data center 110 that provides resources such as, but not limited to, data storage, computing power, databases, networking, analytics, and the like, in one example. In some embodiments, the data center 110 may include the cloud 112, fog, data lake, and the like. However, in other embodiments, the input multimedia content may also be retrieved from other storage means such as, but not limited to, physical storage devices such as local or remote hard disks, CDs, DVDs, Blu-ray disks, and the like. The requested input multimedia content may be communicated from the data center 110 to the edge device 104. It may be noted that in the following description reference is made to use of the cloud 112 as a data center 110. Also, in one example, the data center 110 includes a data storage 114. However, use of other means of computing and storage is also envisaged.

In accordance with aspects of the present specification, to facilitate the context driven processing of the multimedia content, the edge device 104 includes a context driven multimedia processing (CDMP) system 106. The CDMP system 106 is configured to receive the requested input multimedia content. Further, the CDMP system 106, is configured to perform context driven processing of the input multimedia content on the edge device 104 to enhance the quality of the input multimedia content. More particularly, the CDMP system 106 is configured to process, in real-time and on the edge device 104, the received input multimedia content based on contextual information, thereby optimizing of the processing of the input multimedia content and enhancing the quality of user experience.

According to aspects of the present specification, to facilitate the context driven processing of the input multimedia content, the CDMP system 106 is configured to generate context characteristics. The context characteristics are utilized in the context driven processing of the input multimedia content. In one embodiment, the CDMP system 106 is configured to generate the context characteristics based on user characteristics, edge device characteristics, multimedia characteristics, or combinations thereof. To that end, the CDMP system 106 is configured to obtain the user characteristics, the edge device characteristics, and the multimedia characteristics.

The CDMP system 106 is configured to gather characteristics of a user (user characteristics) of the edge device 104. Non-limiting examples of the user characteristics include user preferences, user's usage statistics, user location, user network capabilities, current user environment, and the like. In one example, the user characteristics may be gathered from an application layer of the edge device 104.

Similarly, the CDMP system 106 may be additionally configured to obtain characteristics associated with the edge device 104 (edge device characteristics or device characteristics). Some non-limiting examples of the edge device characteristics include processors of the edge device 104, processing speed of the processors, processing power, capability to handle specific types of operations, accuracy of output, efficiency of specific operations, and the like. In one example, the CDMP system 106 may obtain the edge device characteristics from an application layer of the edge device 104.

Additionally, the CDMP system 106 is configured to extract the multimedia characteristics from the received input multimedia content. In one embodiment, the CDMP system 106 may be configured to perform “content aware” extraction of the multimedia characteristics based on the content of the input multimedia content. Some non-limiting examples of the multimedia characteristics may include a type of the received multimedia content such as a video, a genre of the received multimedia content, temporal variability, spatial variability, special features, presence of specific subjects such as humans, animals, buildings, and the like.

Furthermore, the CDMP system 106 is configured to generate the context characteristics based on the user characteristics, the edge device characteristics, the multimedia characteristics, or combinations thereof. In certain embodiments, the CDMP system 106 employs deep learning techniques that extract context-based features, contextual information, content information, or combinations thereof and corresponding relationships from the user characteristics, the edge device characteristics, and/or the multimedia characteristics. The extracted context-based features, contextual information, and the corresponding relationships are then utilized to generate the context characteristics. The context characteristics are employed to enhance the quality of the streaming multimedia content in real-time on the edge device 104. By way of example, the context characteristics are utilized to enhance one or more of visual quality, aural quality, and information content of the input multimedia content in real-time on the edge device 104.

Moreover, to facilitate the context driven processing of the input multimedia content, the CDMP system 106 is configured to dynamically identify and retrieve a model based on the generated context characteristics. In one embodiment, the model may include a neural network (NN) that is trained and configured to perform one or more tasks or jobs. By way of example, one embodiment of the model may be trained to perform super-resolution of the input multimedia content to enhance the quality of the input multimedia content. Other non-limiting examples of the tasks to be performed by the model include object detection and segmentation, video and/or audio upscaling, multimedia classification, dynamic range enhancement, noise removal, artifact removal, quality enhancement, information content enhancement, and the like. As will be appreciated, a neural network is a computational model that includes several layers. Each layer in the neural network in turn includes several computational nodes. The computational nodes are configured to perform mathematical operations based on received input to generate an output. Some non-limiting examples of the mathematical operations include summation, passing through a non-linearity, comparing a present state of the node with a previous state, and the like. Moreover, the neural network also includes weights that are typically associated between each node in a layer and one or more nodes in subsequent layers. These weights aid in transforming the received input to generate the output.

In one embodiment, the CDMP system 106 may be configured to retrieve the model from the cloud 112 based on the context characteristics, where the model is used to process the input multimedia content. Accordingly, the CDMP system 106 is configured to communicate the context characteristics to the cloud 112 via the Internet 108, in one example. A model that is most suitable/optimized for processing the input multimedia content is identified/selected based on the context characteristics and retrieved from the cloud 112. With continuing reference to the super-resolution example, it may be desirable to enhance the resolution of the input multimedia content.

Accordingly, to identify a suitable model for performing super-resolution, the CDMP system 106 is configured to perform content aware extraction of the multimedia characteristics from the context characteristics. For example, the CDMP system 106 may identify a genre of the input multimedia content, number of bits in the input multimedia content, and the like. Similarly, the CDMP system 106 may also perform edge device aware extraction of the edge device characteristics from the context characteristics. By way of example, the CDMP system 106 may identify the type of edge device 104, the processing power, type of processors in the edge device 104, and the like. Subsequently, a model that is most suited to perform super-resolution of the input multimedia content is identified based on content aware extraction and the edge device aware extraction of the context characteristics. Additionally, in certain embodiments, model metadata corresponding to the identified model may also be retrieved.

Further, in some embodiments, if the suitable model is already available locally on the edge device 104, only the model metadata corresponding to the identified model may be retrieved from the cloud 112. It may be noted that in certain embodiments, the models and/or corresponding model metadata may be generated offline and stored in the cloud 112 or other such data centers.

In some other embodiments, the CDMP system 106 may also include one or more models. In one example, these models may be representative of those models retrieved from the cloud 112. Alternatively or additionally, in some embodiments, the CDMP system 106 may also be configured to generate and host the models locally. In this example, the models may be stored in a local data repository.

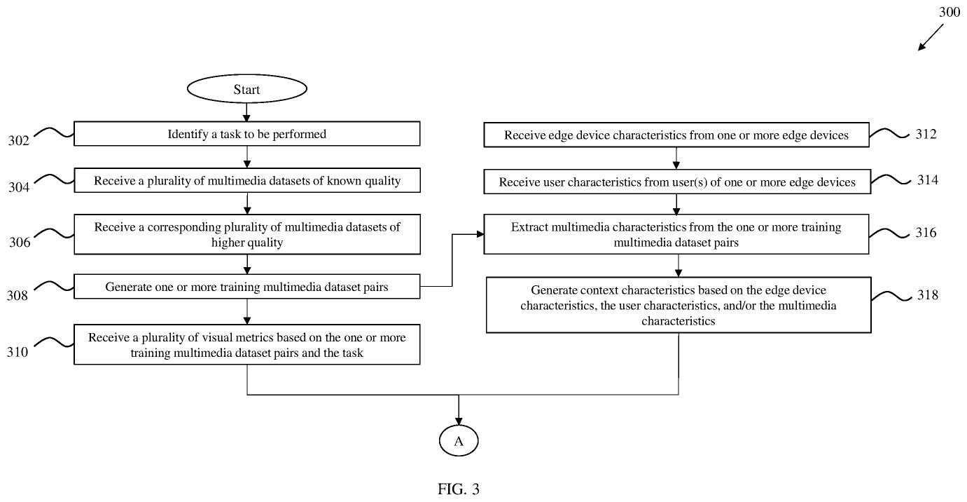

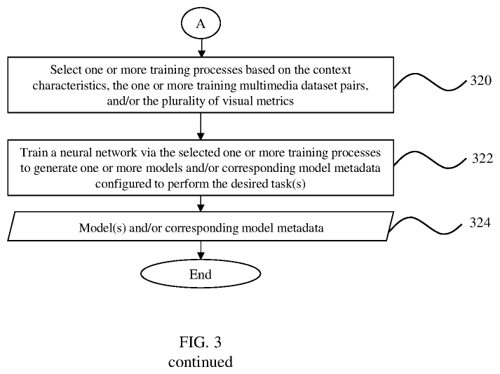

In accordance with aspects of the present specification, the CDMP system 106 is configured to generate one or more models, where each of the one or more models is tuned for performing one or more tasks. The generation of the models will be described in greater detail with reference to FIG. 3.

As noted hereinabove, currently, multimedia streaming is constrained by limited bandwidth availability, high streaming costs, and lack of use of contextual information. In accordance with aspects of the present specification, the CDMP system 106 is designed to circumvent the shortcomings of the presently available techniques for streaming multimedia content. In particular, the CDMP system 106 is configured to process, in real-time on the edge device 104, the input multimedia content based on the one more models and the context characteristics. This processing of the input multimedia content enhances quality of experience for the user 102 of the edge device 104. By way of example, the CDMP system 106 is configured to enhance quality of experience for the viewer of streamed multimedia content on the edge device 104 in real-time and independent of network bandwidth constraints, thereby reducing streaming costs.

As previously noted, the models are trained to perform a task to generate specific desired outputs. In particular, the models, when deployed, aid the CDMP system 106 in processing the input multimedia content by performing a given task to provide a desired enhancement of the incoming input multimedia content. In one example, when the input multimedia content is provided as an input to the model, the model is configured to process the input multimedia content to generate as output processed multimedia content that has a desired higher quality.

Accordingly, the CDMP system 106 is configured to identify one or more processing steps for processing the input multimedia content based on the context characteristics and the model/model metadata. In one embodiment, the CDMP system 106 is configured to perform content aware extraction of the multimedia characteristics from the context characteristics.

Subsequently, the CDMP system 106 is configured to identify one or more processing steps for processing the input multimedia content based at least on the content aware extraction of the multimedia characteristics. By way of example, for the application of performing super-resolution of the input multimedia content, some non-limiting examples of the processing steps include pre-processing of the input multimedia content, video characterization, noise removal, and upscaling.

It may be noted that the upscaling processing may entail temporal upscaling and/or spatial upscaling. In a similar manner, for the example of dynamic range processing of the input multimedia content, the processing steps may include pre-processing, video characterization, dynamic range upscaling, and noise reduction. noise removal, and upscaling. In yet another example of noise/artifact removal from the input multimedia content, the processing steps may include pre-processing, object detection and classification, and segmentation. Moreover, for a quality enhancement of the input multimedia content application, the processing steps include pre-processing, contrast/color/brightness enhancement, and noise removal. Consequently, the content aware abstraction/extraction of the multimedia characteristics from the context characteristics is used to facilitate identification of the processing steps to process the input multimedia content, thereby providing intelligent processing of the input multimedia content and maximizing quality of experience for the user 102.

Moreover, in accordance with aspects of the present specification, edge device awareness provided via the context characteristics is employed to optimize resource utilization and to maximize quality of experience for the user 102. Accordingly, for each identified processing step, the CDMP system 106 is configured to identify, based on the context characteristics and/or the model, a target processing unit in the edge device 104 to perform that processing step. In one embodiment, the CDMP system 106 is configured to perform edge device aware extraction of the edge device characteristics from the context characteristics. Subsequently, for each processing step, the CDMP system 106 is configured to identify one or more target processing units for performing that processing step based at least on the edge device aware extraction of the edge device characteristics. In one example, for each identified processing step, a target processing unit in the edge device 104 may be identified based on computational complexity and/or type of data processing operations associated with the identified processing step and the computational capability (for example, speed, power, and/or accuracy) of the target processing units in the edge device 104. Some non-limiting examples of the target processing units in the edge device 104 include a central processing unit (CPU), a graphics processing unit (GPU), an AI hardware accelerator, a digital signal processing (DSP) unit, a neural processing unit (NPU), and the like.

As noted hereinabove, a target processing unit that is most suited for performing the identified processing step is selected based on the edge device characteristics in the context characteristics and/or the model. With continuing reference to the example of the super-resolution task, if the processing step entails upscaling, the CPU may be identified as the most suitable target processing unit based on the context characteristics and/or the model. Accordingly, the input multimedia content may be communicated to the CPU for optimal processing. Similarly, if the processing step entails video characterization of the input multimedia content, the GPU may be identified as the most suitable target processing unit based on the processing power of the edge device 104 encoded in the context characteristics and/or the model. Consequently, use of the edge device characteristics in the form of the context characteristics and the model enables optimization of resource utilization, which in turn minimizes consumption of additional power for the context driven processing by the edge device 104, thereby facilitating low power operation of the edge device 104.

Each processing step is then executed on the identified target processing unit to generate an output that includes multimedia content with enhanced quality and/or information content. In particular, the incoming input multimedia content is processed, in real-time on the edge device 104, by the identified target processing units to perform the processing steps based on the context characteristics and/or the model/model metadata. Consequent to this processing, an improved output multimedia content is generated. In certain embodiments, the improved output multimedia content may include output that has enhanced visual quality, enhanced aural quality, enhanced information content, and the like. In the example of the super-resolution task, consequent to the processing by the identified target processing units, the improved output multimedia content may include output that has “super-resolved” multimedia content having a higher pixel density and consequently more details.

The improved output multimedia content so generated may then be provided, in real-time, on the edge device 104. In one embodiment, the system 100 may include an interface unit that is configured to provide the improved output multimedia content, in real-time on the edge device 104. By way of a non-limiting example, the improved output multimedia content may be visualized on a display of the edge device 104. In accordance with aspects of the present specification, the improved output multimedia content may be visualized on the display by dynamically reconfiguring the display to receive and visualize the improved output multimedia content.

In accordance with exemplary aspects of the present specification, use of the context characteristics facilitates “context aware” or “context driven” intelligent processing of the input multimedia content on the edge device 104, thereby achieving superior quality in real-time. Additionally, use of the context characteristics facilitates “edge device” aware processing of the input multimedia content, thereby optimizing power consumed by the edge device 104. In particular, performing context driven processing of the input multimedia content on the edge device 104 results in an additional consumption of less than 1% power in comparison to power consumption of the edge device 104 when the context driven processing is not performed. Additionally, the context driven processing of the input multimedia content is performed independent of network bandwidths constraints and provides a solution that is agnostic of the currently available infrastructure.

Implementing the CDMP system 106 as described hereinabove on the edge device 104 aids in enhancing the performance of the edge device 104 by providing an enriched streaming of the multimedia content in real-time and low power, while obviating the dependency on network bandwidth availability and reducing transmission cost. Additionally, use of the CDMP system 106 on the edge device 104 provides real-time AI-based enhancement of the quality of the input multimedia content on the edge device 104. Moreover, the context aware capability provided by the CDMP system 106 aids in optimizing system level workflow.

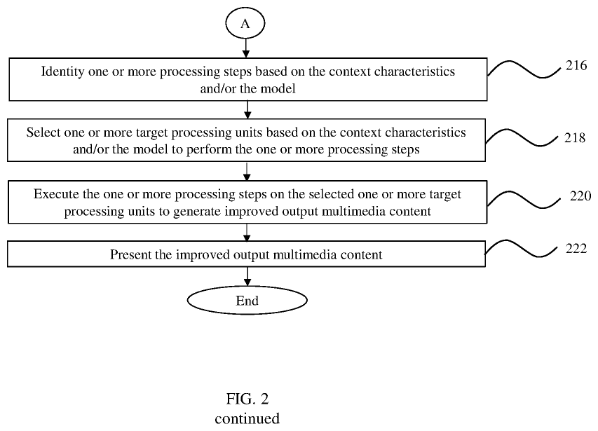

Embodiments of the exemplary methods of FIGS. 2-3 may be described in a general context of computer executable instructions on computing systems or a processor. Generally, computer executable instructions may include routines, programs, objects, components, data structures, procedures, modules, functions, and the like that perform particular functions or implement particular abstract data types.

Moreover, the embodiments of the exemplary methods may be practised in a distributed computing environment where optimization functions are performed by remote processing devices that are linked through a wired and/or wireless communication network. In the distributed computing environment, the computer executable instructions may be located in both local and remote computer storage media, including memory storage devices.

In addition, in FIGS. 2-3, the exemplary methods are illustrated as a collection of blocks in a logical flow chart, which represents operations that may be implemented in hardware, software, firmware, or combinations thereof. It may be noted that the various operations are depicted in the blocks to illustrate the functions that are performed. In the context of software, the blocks represent computer instructions that, when executed by one or more processing subsystems, perform the recited operations.

Moreover, the order in which the exemplary methods are described is not intended to be construed as a limitation, and any number of the described blocks may be combined in any order to implement the exemplary methods disclosed herein, or equivalent alternative methods. Further, certain blocks may be deleted from the exemplary methods or augmented by additional blocks with added functionality without departing from the spirit and scope of the subject matter described herein.

Referring to FIG. 2, a flow chart 200 of an exemplary method for context driven processing of multimedia content on an edge device, in accordance with aspects of the present specification, is presented. In one embodiment, the method 200 entails enhancing, in real-time, the quality of multimedia content on the edge device. The method 200 of FIG. 2 is described with reference to the components of FIG. 1. Moreover, in certain embodiments, the method 200 may be performed by the CDMP system 106. Also, the method of FIG. 2 is described in terms of the input multimedia content including video content and the application or task being performed includes super-resolution of the input multimedia content to generate output multimedia content having higher resolution.

The method starts at step 202 when the user 102 makes a request for multimedia content on the edge device 104. Once the edge device 104 detects the request for streaming multimedia content from the user 102, the edge device 104 may retrieve the requested input multimedia content from a data center 110 such as the cloud 112. It may also be noted that in certain other embodiments, the input multimedia content may be retrieved from other storage means such as, but not limited to, physical storage devices such as local or remote hard disks, CDs, DVDs, Blu-ray disks, and the like. The requested input multimedia content may be transmitted from the cloud 112 to the edge device 104, as indicated by step 204. In one example, the input multimedia content may be communicated to an acquisition subsystem in the CDMP system 106 on the edge device 104. Further, the acquisition subsystem may be configured to transmit the received input multimedia content to a processing subsystem in the CDMP system 106 for further processing. Alternatively, in certain embodiments, the input multimedia content may be directly communicated to the processing subsystem in the CDMP system 106.

In accordance with exemplary aspects of the present specification, a method that provides significant improvement in quality of experience for end users, while circumventing the shortcomings of the currently available techniques such as dependence on availability of network bandwidths and higher streaming costs, is presented. More particularly, the method 200 entails context driven processing the input multimedia content, in real-time on the edge device 104, based on contextual information, thereby customizing optimization of the processing of the input multimedia content.

Accordingly, to facilitate the processing of the input multimedia content based on contextual information, edge device characteristics corresponding to the edge device 104 may be obtained, as depicted by step 206. For example, the CDMP system 106 is configured to obtain edge device characteristics corresponding to the edge device 104 such as, but not limited to, processors of the edge device 104, processing speed of the processors, power, capability to handle specific types of operations, accuracy of output, efficiency of specific operations, and the like. The CDMP system 106 may obtain the edge device characteristics from an application layer of the edge device 104.

In addition, user characteristics corresponding to the user 102 may be obtained, as indicated by step 208. In one example, the CDMP system 106 is configured to acquire the user characteristics such as, but not limited to, user preferences, user's usage statistics, user location, user network capabilities, current user environment, and the like, from an application layer of the edge device 104.

Moreover, as depicted by step 210, multimedia characteristics corresponding to the input multimedia content may be obtained. By way of example, the CDMP system 106 may be configured to extract the multimedia characteristics from the input multimedia content. Some examples of the multimedia characteristics include a type of the received video, a genre of the received video, temporal variability, spatial variability, special features, presence of specific subjects such as humans, animals, buildings, and the like.

Once the user characteristics, the edge device characteristics, and the multimedia characteristics are gathered, context characteristics may be generated, as generally indicated by step 212. As previously noted, in some embodiments, the CDMP system 106 is configured to utilize deep learning techniques to extract context-based features, contextual information, content information, or combinations thereof and corresponding relationships from the user characteristics, the edge device characteristics, the multimedia characteristics, or combinations thereof. Subsequently, the CDMP system 106 is configured to generate the context characteristics based on the extracted context-based features, contextual information, and the corresponding relationships. The context characteristics so generated are then used to facilitate the context driven processing of the input multimedia content to provide enhanced quality of viewing for the user 102.

Subsequently, at step 214, a model and/or model metadata are retrieved based on the context characteristics. It may be noted that in certain embodiments, the models and/or corresponding model metadata may be generated offline and stored in the cloud 112 or other such data centers. Additionally or alternatively, the models may also be stored locally on the edge device 104.

In one embodiment, the CDMP system 106 may be configured to dynamically identify and retrieve the model and/or model metadata from the cloud 112. Accordingly, the context characteristics are communicated to the cloud 112 along with a request to identify a suitable model for processing the input multimedia content. A model that is most suitable for processing the input multimedia content is identified based on the context characteristics and retrieved from the cloud 112. By way of example, to identify a model that is best suited to perform super-resolution of the input multimedia content, the CDMP system 106 is configured to perform content aware extraction of the multimedia characteristics from the context characteristics to identify a genre of the input multimedia content, number of bits in the input multimedia content, and the like. In a similar fashion, the CDMP system 106 may also perform edge device aware extraction of the edge device characteristics from the context characteristics to identify the type of edge device 104, the processing power, type of processors, and the like. Subsequently, a model that is most suited for performing super-resolution of the input multimedia content is identified based at least on content aware extraction and the edge device aware extraction from the context characteristics. In certain embodiments, model metadata corresponding to the identified model may also be retrieved.

It may be noted that if a suitable model to process the input multimedia content is not identified, a default model may be used. In certain embodiments, the default model may be retrieved from the cloud 112. Alternatively, the default model may be retrieved from a local data repository on the edge device 104. Furthermore, if the suitable model is already available locally on the edge device 104, only the model metadata corresponding to the identified suitable model may be retrieved.

Moreover, once the model and/or model metadata have been identified and retrieved, the CDMP system 106 may be configured to process the input multimedia content using the model, the model metadata, the context characteristics, or combinations thereof. As previously noted hereinabove, the models are trained to perform a task to generate a specific desired output. The models, when deployed, process the input multimedia content by performing a given task to provide a desired enhancement of the incoming input multimedia content. By way of continuing reference to the super-resolution example, when the input multimedia content is provided as an input to the model, the input multimedia content is processed by the model and/or model metadata to generate as output processed multimedia content that has a desired higher quality.

Accordingly, to facilitate the processing of the input multimedia content based on the context characteristics and the model/model metadata, the CDMP system 106 is configured to identify one or more processing steps for processing the input multimedia content, as depicted by step 216. In one embodiment, the CDMP system 106 is configured to perform content aware extraction of the multimedia characteristics provided in the context characteristics. The CDMP system 106 is configured to subsequently identify one or more processing steps for processing the input multimedia content based at least on the content aware extraction of the multimedia characteristics. By way of example, for the task of performing super-resolution of the input multimedia content, some non-limiting examples of the processing steps include pre-processing of the input multimedia content, video characterization, noise removal, and upscaling. It may be noted that the upscaling processing may entail temporal upscaling and/or spatial upscaling. In a similar manner, to perform a dynamic range processing task, the processing steps may include pre-processing, video characterization, dynamic range upscaling, and noise reduction. Moreover, to perform the task of noise/artifact removal, the processing steps may include pre-processing, video characterization, noise removal, and artifact removal. Similarly, to perform a segmentation and object detection task, the processing steps may include pre-processing, object detection and classification, and segmentation. Further, to perform a quality enhancement task, the processing steps include pre-processing, contrast/color/brightness enhancement, and noise removal. Consequently, the content aware abstraction/extraction of the multimedia characteristics from the context characteristics is used to facilitate identification of the processing steps to process the input multimedia content, thereby providing intelligent processing of the input multimedia content and maximizing quality of experience for the user 102.

Furthermore, in accordance with aspects of the present specification, for each processing step, a target processing unit in the edge device 104 that is most suitable for performing that processing step may be identified, as indicated by step 218. In particular, edge device awareness provided by the context characteristics is employed to optimize resource utilization and to maximize quality of experience for the user 102.

In certain embodiments, the CDMP system 106 is configured to perform edge device aware extraction of the edge device characteristics provided by the context characteristics. Subsequently, for each processing step, the CDMP system 106 is configured to identify one or more target processing units for performing that processing step based at least on the edge device aware extraction of the edge device characteristics. Specifically, for each processing step, the CDMP system 106 is configured to identify one or more target processing units for performing that processing step based at least on the edge device aware extraction of the edge device characteristics. In one example, for each identified processing step, a target processing unit in the edge device 104 may be identified based on computational complexity and/or type of data processing operations associated with the identified processing step and the computational capability (for example, speed, power, and/or accuracy) of the target processing units in the edge device 104. As previously noted with reference to FIG. 1, some non-limiting examples of the target processing units in the edge device 104 include a CPU, a GPU, an AI hardware accelerator, a DSP unit, an NPU, and the like. With continuing reference to the example of the super-resolution task, if the processing step entails upscaling, the CPU may be identified as the most suitable target processing unit based on the context characteristics and/or the model and the input multimedia content may be communicated to the CPU for optimal processing. In a similar fashion, if the processing step entails video characterization of the input multimedia content, the GPU may be identified as the most suitable target processing unit based on the processing power of the edge device 104 encoded in the context characteristics and/or the model. Hence, use of the edge device awareness provided via the edge device characteristics in the form of the context characteristics and the model enables optimization of resource utilization, which in turn minimizes consumption of additional power for the context driven processing by the edge device 104 to facilitate low power operation of the edge device 104.

Subsequently, at step 220, each processing step is executed on the identified suitable target processing unit(s) to generate an output that includes multimedia content with enhanced quality and/or information content. In particular, the incoming input multimedia content is processed by the identified target processing unit(s) to perform the selected processing step(s) based on the context characteristics and/or the model/model metadata. Consequent to this processing, improved output multimedia content is generated. In certain embodiments, the improved output multimedia content may include enhanced visual quality, enhanced aural quality, enhanced information content, and the like. In the example of the super-resolution task, consequent to the processing of step 220, the improved output multimedia content may include output that has “super-resolved” multimedia content having a higher pixel density and more details.

Additionally, at step 222, the improved output multimedia content so generated may then be presented or provided, in real-time, to the user 102. In one example, the improved output multimedia content may be visualized on a display device of the edge device 104. In certain embodiments, the improved output multimedia content may be visualized on the display by dynamically reconfiguring the display to receive and visualize the improved output multimedia content. More particularly, display characteristics of the display may be dynamically changed to accept and visualize the processed output generated by the CDMP system 106. By way of example, the display that is currently configured to visualize the low-quality input multimedia content may be dynamically reconfigured to accept and visualize the improved higher quality output multimedia content generated by the CDMP system 106. In one embodiment, a rendering unit in the edge device 104 may be used to dynamically reconfigure the display to visualize the improved output multimedia content.

Turning now to FIG. 3, a flow chart 300 of an exemplary method for generating a model, in accordance with aspects of the present specification, is presented. In particular, the method 300 details a training process to generate one or more models for use in processing input multimedia content to enhance, in real-time, the quality of multimedia content on an edge device. The method 300 of FIG. 3 is described with reference to the components of FIGS. 1-2. Additionally, in certain embodiments, the models may be generated offline and stored in a data center such as the cloud 112. However, in some other embodiments, the method 300 may be performed by the CDMP system 106 to generate one or more models. In some other examples, the models may also be stored locally on the edge device 104.

As previously noted, the model may include a neural network that is trained and configured to perform one or more tasks or jobs. For example, one model may be trained to perform a task of super-resolution. Other non-limiting examples of the tasks to be performed by the model include object detection, object segmentation, video and/or audio upscaling, multimedia classification, dynamic range enhancement, noise removal, artifact removal, quality enhancement, information content enhancement, and the like.

One example of a training process to generate a model is presented in FIG. 3. Also, the training process presented herein is described using video as input and output multimedia datasets. However, the training process may also be used with other types of multimedia content. Moreover, in the example presented in FIG. 3, a model may be trained to perform a super-resolution task, where the super-resolution task to be performed by the model may entail improving or enhancing visual quality of an input video by recovering information content that is typically lost during the process of encoding the video at a low bit rate. It may be noted that a similar training process may also be extended to generate models to process different types of multimedia content to enhance any type of quality of a low quality input and/or enhance information content of a low information content input.

As noted hereinabove, a model generated by the method 300 of FIG. 3 is trained to perform one or more tasks. The method 300 starts at step 302, where a task to be performed by a given model is identified. In one example, the task to be performed is determined based on an application or task that a given model is being trained to perform. As previously noted, some non-limiting examples of desired tasks include super-resolution, object detection, object classification, object segmentation, video and/or audio upscaling, multimedia classification, noise removal, artifact removal, quality enhancement, information content enhancement, dynamic range upscaling, optimization of one or more of the visual metrics, and the like. It may be noted that a model may be trained to perform one or more tasks. Accordingly, at step 302, one or more tasks to be performed by a given model may be identified. Subsequently, based on the identified task, model training dataset pairs (input and desired output) are generated or obtained. Accordingly, at step 304, based on the task to be performed, a plurality of multimedia datasets having a known quality and/or content is received (input multimedia datasets). In one embodiment, the input multimedia datasets may be obtained, while in certain other embodiments, the input multimedia datasets may be generated based on the task to be performed. Also, in another example, the input multimedia datasets may be received from open source databases or user generated content. In one example, the input multimedia datasets obtained or generated at step 304 may include multimedia content having low quality and/or low information content. Also, the input multimedia datasets having low information content and/or low quality may be provided to a neural network as an input.

Additionally, another plurality of multimedia datasets having a higher quality and/or higher information content (output multimedia datasets) is received, as indicated by step 306. In one embodiment, the output multimedia datasets may be obtained, while in some other embodiments, the output multimedia datasets may be generated based on the task at hand. Moreover, in one example, the output multimedia datasets may be received from open source databases or user generated content. The output multimedia datasets are generally representative of multimedia datasets having a desired known higher quality and/or known higher information content. In one example, the output multimedia datasets having higher quality and/or higher information content correspond to the input multimedia datasets having low quality and/or low information content. Further, the output multimedia datasets having higher information content and/or higher quality may be provided to the neural network as a desired output.

Subsequently, at step 308, one or more training multimedia dataset pairs are generated. Each training multimedia dataset pair is generated by including an input multimedia dataset and a corresponding output multimedia dataset. More particularly, in one embodiment, the training multimedia dataset pairs may be generated based on the task identified at step 302. However, in another embodiment, the training multimedia dataset pairs may be obtained based on the task to be performed by a model. These training multimedia dataset pairs are used to train a neural network.

In addition, a plurality of visual metrics is received, as depicted by step 310. Specifically, in certain embodiments, the plurality of visual metrics is retrieved based on the task that the neural network/model is being trained to perform. However, in certain other embodiments, the plurality of visual metrics may be generated based on the task to be performed. Subsequently, these visual metrics may be combined in an optimal fashion and employed to train a model to produce an output that is substantially similar to a desired output. The plurality of visual metrics so combined may be provided to the neural network as an input. In one example, the combination of the plurality of visual metrics may be provided as an input to train the neural network to facilitate maximization/optimization of the visual metrics. Some non-limiting examples of the visual metrics include peak signal-to-noise ratio (PSNR), structural similarity index (SSIM), visual loss metric, perceptual quality metrics, and the like.

Furthermore, at step 312, edge device characteristics corresponding to one or more edge devices may be obtained. The one or more edge devices may include edge devices that are in communication with the cloud 112. As previously noted, some examples of the edge device characteristics include processors of the edge device, processing speed of the processors, processing power, capability to handle specific types of operations, accuracy of output, efficiency of specific operations, and the like.

In addition, user characteristics may be gathered from a plurality of users of a plurality of edge devices communicating with the cloud 112, as depicted by step 314. As noted hereinabove, some examples of the user characteristics include user preferences, user's usage statistics, user location, user network capabilities, current user environment, and the like.

Moreover, at step 316, multimedia characteristics may be extracted from the input multimedia datasets, the output multimedia datasets, and/or the one or more training multimedia dataset pairs. Some non-limiting examples of the multimedia characteristics may include a type of the received video, a genre of the received video, temporal variability, spatial variability, special features, presence of specific subjects such as humans, animals, buildings, and the like.

Subsequently, as indicated by step 318, context characteristics may be generated based on the edge device characteristics, the user characteristics, and/or the multimedia characteristics respectively obtained at steps 312, 314, and 316. In one example deep learning techniques are employed to extract context-based features, contextual information, content information, or combinations thereof and corresponding relationships from the user characteristics, the edge device characteristics, and/or the multimedia characteristics. The extracted context-based features, contextual information, and the corresponding relationships are then utilized to generate the context characteristics. It may be noted that in certain embodiments, the training multimedia dataset pairs may be further refined based on the edge device characteristics, the user characteristics, and/or the video characteristics to accurately represent the context.

It may be noted that steps 302-310 and steps 312-318 may be performed in parallel. However, in another example, steps 302-310 and steps 312-318 may be performed in a serial manner.

With continuing reference to FIG. 3, at step 320, one or more training processes are selected based on the context characteristics, the one or more training multimedia dataset pairs, and/or the plurality of visual metrics. In one embodiment, the one or more training processes are used to train a neural network to perform the task identified at step 302. It may be noted that the selected training processes may be configured to run in parallel or in a serial manner to train the neural network to perform the task(s) at hand.

Once the one or more training processes are selected, a neural network may be trained using the selected training processes to generate one or more models and/or model metadata 324, as depicted by step 322. In certain embodiments, the neural network may be trained via the selected training processes by providing the plurality of input multimedia datasets of known quality, a corresponding plurality of output multimedia datasets of higher quality, and the plurality of visual metrics as inputs to the neural network. More particularly, the neural network is trained employing the training processes using the training multimedia dataset pairs and the plurality of visual metrics to generate a model that is configured or trained to perform the task(s) identified at step 302. In one example, selecting the training processes may entail determining one or more parameters corresponding to the training processes to optimize performance of a model configured to perform the identified task. Some non-limiting examples of the parameters include an optimization routine, a loss function, a training duration, a learning rate, and the like.

Subsequent to the training of the neural network, one or more models may be generated, where each model is configured to perform a corresponding task. In certain other embodiments, the models so generated may also be trained to perform more than one task. The models and/or model metadata 324 may be communicated to the edge device 104 in response to a request received from the edge device 104. Moreover, the models and/or model metadata 324 so generated may be stored on the cloud 112 and/or locally in a data repository on the edge device 104.

Consequent to the training process of step 322, one or more models 324 configured to perform one or more tasks are generated. It may be noted that in some embodiments, the generated model 324 may be represented by corresponding model metadata. However, in other examples, the model metadata may be generated in addition to the model 324. The model metadata may be generated at the end of the training process. In the example of super-resolution entailing video quality enhancement, the model metadata may be generally representative of information loss between a low quality input and a desired high quality output. In accordance with aspects of the present specification, the model 324 and/or the model metadata may be used on the edge device 104 to enhance the quality of experience for the user 102.

One example of the training process 300 presented hereinabove is described with reference to an application or task that includes super-resolution of input multimedia content such as a video. Accordingly, the task identified at step 302 is super-resolution of a video. Further, for the task of performing super-resolution of the video, one or more low-resolution videos may be obtained at step 304. Similarly, at step 306, high-resolution videos corresponding to the low-resolution videos retrieved at step 304 may be obtained. In addition, at step 308, training video pairs may be generated using the low-resolution videos and the corresponding high-resolution videos. Also, at step 310, one or more visual metrics such as, but not limited to, PSNR, SSIM, visual loss metric, and perceptual quality metrics are obtained.

At steps 312 edge device characteristics corresponding to a plurality of edge devices communicating with the cloud 112 are obtained. Similarly, user characteristics corresponding to a plurality of users of edge devices in communication with the cloud 112 are obtained at step 314. Furthermore, at step 316, multimedia characteristics such as video characteristics are extracted from the low-resolution videos, the corresponding high-resolution videos, and/or the training video pairs. Context characteristics are then generated at step 318 based on the edge device characteristics, the user characteristics, and/or the video characteristics. Moreover, in some embodiments, the training video pairs may be further refined based on the edge device characteristics, the user characteristics, and/or the video characteristics to accurately represent the context.

Subsequently, at step 320, one or more training processes to train a neural network may be selected based on the context characteristics, the training video pairs, and/or the visual metrics. With continuing reference to the super-resolution task example, selecting the training processes entails determining one or more parameters of the training processes to optimize performance of a model configured to perform the identified task of super-resolution. In a non-limiting example, the parameters may include an optimization routine, a loss function, a training duration, a learning rate, and the like. Furthermore, at step 322, a neural network may be trained using the selected training processes to generate one or more models and/or model metadata 324.

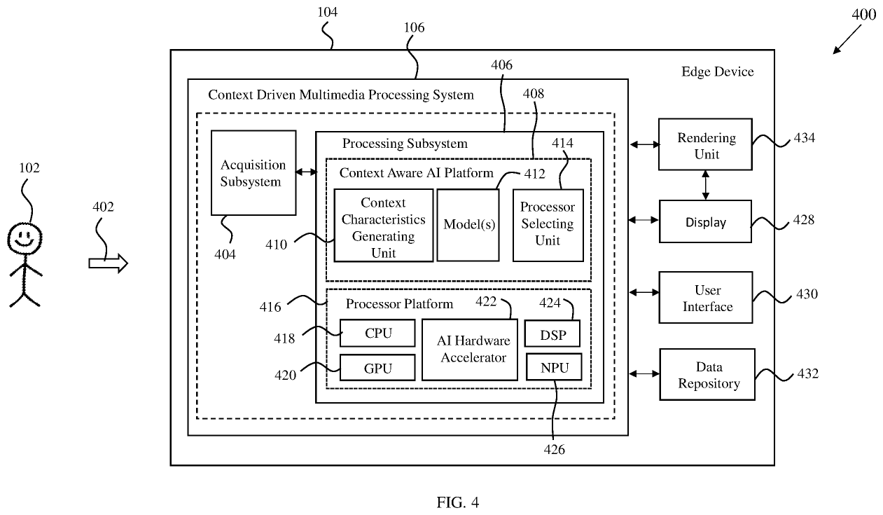

Referring now to FIG. 4, one embodiment 400 of the edge device 104 of FIG. 1, in accordance with aspects of the present specification, is presented. It may be noted that FIG. 4 is described with reference to the components of FIGS. 1-3. Moreover, the system 400 of FIG. 4 is described in terms of the input multimedia content including video content and the application or task being performed includes super-resolution of the input multimedia content to generate output multimedia content having higher resolution. However, the system 400 may also find application in processing other multimedia content such as audio data, images, graphics, text, games, graphic objects, animation sequences, and the like. Also, as previously noted, the edge device 104 may be a mobile phone, a smart TV, a tablet, a laptop, a streaming media player, a gaming device/console, a router, a modem, and the like.

As previously noted with reference to FIG. 1, the edge device 104 includes the context driven multimedia processing (CDMP) system 106. The CDMP system 106 is configured to receive requested multimedia content 402. It may be noted that the requested multimedia content may generally be referred to as input multimedia content 402. As previously described with reference to FIG. 1, the user 102 may make a request for multimedia content. In one example, the user 102 may make a request to view streaming multimedia content on the edge device 104.

Further, the CDMP system 106 is configured to perform context driven processing of the input multimedia content 402 on the edge device 104 to substantially improve the quality of the input multimedia content 402. In certain embodiments, the CDMP system 106 is configured to perform context driven processing of the input multimedia content 402, in real-time, on the edge device 104, while facilitating low power operation of the edge device 104.

Additionally, as depicted in FIG. 4, in a presently contemplated configuration, the CDMP system 106 includes an acquisition subsystem 404 and a processing subsystem 406 that is operatively coupled to the acquisition subsystem 404. The acquisition subsystem 404 is configured to receive the requested input multimedia content 402. Moreover, the acquisition subsystem 404 is configured to communicate the input multimedia content 402 to the processing subsystem 406. However, in some other embodiments, the input multimedia content 402 may be directly communicated to the processing subsystem 406.

In accordance with aspects of the present specification, the processing subsystem 406 is configured to perform, in real-time, context driven processing of the input multimedia content 402 to enhance the quality of the input multimedia content 402. In one embodiment, the processing subsystem 406 may include a context aware artificial intelligence (AI) platform 408 and a processor platform 416. However, the processing subsystem 406 may also include other units. It may be noted that although the embodiment depicted in FIG. 4 depicts the processing subsystem 406 as including the context aware AI platform 408, in some embodiments, the context aware AI platform 408 may be employed as a standalone unit that is physically separate from the processing subsystem 406.

The context aware AI platform 408 is configured to process, in real-time, the received input multimedia content 402. In particular, the context aware AI platform 408 is configured to process the input multimedia content 402, in real-time, based on contextual information, thereby customizing optimization of the processing of the input multimedia content 402. In one embodiment, the context aware AI platform 408 may include a context characteristics generating unit 410 and a processor selecting unit 414. Reference numeral 412 is generally used to represent one or more models.

In accordance with aspects of the present specification, the context characteristics generating unit 410 is configured to generate context characteristics. In one embodiment, the context characteristics includes multimedia characteristics, user characteristics, edge device characteristics, or combinations thereof. The context characteristics so generated are then used to facilitate the context driven processing of the input multimedia content 402 to provide enhanced quality of viewing for the user 102.

With continuing reference to FIG. 1, to generate the context characteristics, the context characteristics generating unit 410 is configured to obtain the user characteristics, the edge device characteristics, and the multimedia characteristics. In particular, the context characteristics generating unit 410 is configured to extract the multimedia characteristics from the input multimedia content 402. As previously noted, the multimedia characteristics may include a type of the input multimedia content 402, a genre of the input multimedia content 402, temporal variability, spatial variability, special features, presence of specific subjects such as humans, animals, buildings, and the like.

In a similar fashion, the context characteristics generating unit 410 may also be configured to gather user characteristics. Some non-limiting examples of the user characteristics include user preferences, user's usage statistics, user location, user network capabilities, current user environment, and the like. In one example, the context characteristics generating unit 410 may obtain the user characteristics from an application layer of the edge device 104.

Further, the context characteristics generating unit 410 may be additionally configured to obtain the edge device characteristics. Non-limiting examples of the edge device characteristics include processors of the edge device 104, processing speed of the processors, processing power, capability to handle specific types of operations, accuracy of output, efficiency of specific operations, and the like. By way of example, the context characteristics generating unit 410 may obtain the edge device characteristics from an application layer of the edge device 104.

The context characteristics generating unit 410 is configured to generate the context characteristics based on the multimedia characteristics, the user characteristics, the edge device characteristics, or combinations thereof. In certain embodiments, to generate the context characteristics, the context characteristics generating unit 410 employs deep learning techniques to extract context-based features, contextual information, content information, or combinations thereof and corresponding relationships from the user characteristics, the edge device characteristics, and/or the multimedia characteristics. The extracted context-based features, contextual information, and the corresponding relationships are then utilized to generate the context characteristics. The context characteristics are employed to enhance one or more of visual quality, aural quality, and information content of the input multimedia content 402, in real-time, on the edge device 104.

Further, the context aware AI platform 408 is configured to process the input multimedia content 402 based on the context characteristics. To that end, the CDMP system 106 is configured to dynamically identify and retrieve a model 412 based on the generated context characteristics. In one embodiment, the CDMP system 106 may be configured to retrieve the model 412 from the cloud 112 based on the context characteristics, where the model 412 is used to process the input multimedia content 402. Accordingly, to facilitate the identification and retrieval of a suitable model 412, the CDMP system 106 is configured to communicate the context characteristics to the cloud 112 via the Internet 108, in one example.

A model 412 that is most suitable or optimized for processing the input multimedia content 402 is identified based on the context characteristics and retrieved from the cloud 112. With continuing reference to the super-resolution task example, it may be desirable to enhance the resolution of the input multimedia content 402. Accordingly, to identify the most suitable model 412 for performing the super-resolution task, the CDMP system 106 is configured to perform content aware extraction of the multimedia characteristics from the context characteristics. For example, the CDMP system 106 may identify a genre of the input multimedia content 402, number of bits in the input multimedia content 402, and the like. Similarly, the CDMP system 106 may also perform edge device aware extraction of the edge device characteristics from the context characteristics. By way of example, the CDMP system 106 may identify the type of edge device 104, the processing power, type of processors, and the like.

Subsequently, a model 412 that is most suited to perform super-resolution of the input multimedia content 402 is identified based on content aware extraction and the edge device aware extraction of the context characteristics. For example, to perform super-resolution of the input multimedia content 402, a suitable model 412 that is trained to enhance the video quality and optimize processing speed may be dynamically selected based on the content aware extraction of the multimedia characteristics and/or the edge device aware extraction of the edge device characteristics. Additionally, in certain embodiments, model metadata corresponding to the identified model 412 may also be retrieved. In certain embodiments, if the suitable model 412 is available locally on the edge device 104, only the model metadata corresponding to the identified model 412 may be retrieved from the cloud 112.

As previously noted, the models 412 may be generated offline and stored in the cloud 112 or other such data centers. In certain embodiments, the context aware AI platform 408 may also include one or more models 412. In this example, the models 412 may be representative of those models retrieved from the cloud 112. Alternatively or additionally, in some embodiments, the context aware AI platform 408 may also be configured to generate the models 412 and host the models 412 so generated locally. In this example, the models 412 may be stored in a local data repository 432.

Furthermore, as previously noted, the models 412 may be generated by training a neural network. Specifically, consequent to the training process, a model may be generated to perform a given task. One example of a task to be performed by the model may include video quality enhancement of the input multimedia content 402 via super-resolution. Other non-limiting examples of the tasks include object segmentation, video and/or audio upscaling, multimedia classification, dynamic range enhancement, noise removal, artifact removal, quality enhancement, information content enhancement, maximization/optimization of one or more of the visual metrics, and the like.

In certain embodiments, the generated model 412 may be represented by corresponding model metadata. However, in other embodiments, model metadata corresponding to a given model may also be generated. In the example of video quality enhancement via super-resolution, this model metadata may be generally representative of information loss between a low quality input and a desired high quality output. The model metadata may be used on the edge device 104 to enhance the quality of experience for the user 102.

As noted hereinabove, currently, multimedia streaming is constrained by limited bandwidth availability, high streaming costs, and lack of contextual information. In accordance with aspects of the present specification, the CDMP system 106 is designed to circumvent the shortcomings of the presently available techniques for streaming multimedia content. In particular, the CDMP system 106 and more particularly the context aware AI platform 408 is configured to enhance quality of experience for a viewer of streamed multimedia content on the edge device 104 in real-time and independent of network bandwidth constraints, thereby reducing streaming costs. According to aspects of the present specification, the context aware AI platform 408 is configured to process the streaming input multimedia content 402, in real-time, on the edge device 104 via use of one or more models 412 and the context characteristics to enhance the quality of experience for the user 102 on the edge device 104, thereby obviating the disadvantages of the currently available streaming techniques.

Moreover, as previously noted, the models 412 are trained to perform tasks to generate specific desired outputs. In particular, the models 412, when deployed, aid the context aware AI platform 408 in performing a given task to provide a desired enhancement of the incoming input multimedia content 402. For example, the context aware AI platform 408 may be configured to use a model 412 to process the input multimedia content 402, in real-time and on the edge device 104, to enhance the quality of the input multimedia content 402. Accordingly, in the super-resolution task example, when the input multimedia content 402 is provided as an input to the model 412, the model 412 is configured to process the input multimedia content 402 to generate as output processed multimedia content that has a desired higher quality. In particular, the model 412 is configured to process the input multimedia content 402 to enhance the quality of the input multimedia content 402 via super-resolution to generate output processed multimedia content having the desired higher quality. The output multimedia content having the desired higher quality may be provided to the user 102 via the edge device 104.

Subsequent to the identification and retrieval of the model 412 and/or model metadata, the context aware AI platform 408 may be configured to identify one or more processing steps for processing the input multimedia content 402. More particularly, the context aware AI platform 408 may be configured to identify the one or more processing steps based on the context characteristics and the model/model metadata 412. In accordance with aspects of the present specification, the context aware AI platform 408 is configured to perform content aware extraction of the multimedia characteristics from the context characteristics. Subsequently, the context aware AI platform 408 is configured to identify one or more processing steps for processing the input multimedia based at least on the content aware extraction of the multimedia characteristics.

By way of example, for the task of performing super-resolution of the input multimedia content 402, some non-limiting examples of the processing steps that may be identified based on the content aware extraction of the multimedia characteristics may include pre-processing of the input multimedia content 402, video characterization, noise removal, and upscaling. It may be noted that the upscaling processing may entail temporal upscaling and/or spatial upscaling. In a similar manner, for a task of dynamic range processing, the identified processing steps may include pre-processing, video characterization, dynamic range upscaling, and noise reduction. Consequently, the content aware abstraction/extraction of the multimedia characteristics from the context characteristics is used to facilitate identification of the processing steps to process the input multimedia content 402, thereby providing intelligent processing of the input multimedia content 402 and maximizing quality of experience for the user 102.

In accordance with further aspects of the present specification, edge device awareness provided via the context characteristics is employed to optimize resource utilization and to maximize quality of experience for the user 102 via use of the processor platform 416. In a presently contemplated configuration, the processor platform 416 is shown as including a plurality of target processing units. More particularly, the processor platform 416 includes a central processing unit (CPU) 418, a graphics processing unit (GPU) 420, an AI hardware accelerator 422, a digital signal processing (DSP) unit 424, and a neural processing unit (NPU) 426. However, the processor platform 416 may include fewer target processing units or a greater number of target processing units based on the type of edge device 104.

Moreover, in accordance with aspects of the present specification, the context aware AI platform 408 is configured to perform edge device aware extraction of the edge device characteristics from the context characteristics. Further, edge device awareness provided via the edge device aware extraction is used to optimize resource utilization and to maximize quality of experience for the user 102. Accordingly, for each processing step, the context aware AI platform 408 is configured to identify one or more target processing units in processor platform 416 of the edge device 104 for performing that processing step based at least on the edge device aware extraction of the edge device characteristics.

Specifically, for each processing step, a target processing unit in the processor platform 416 of the edge device 104 that is best suited to perform that processing step is identified based at least on the edge device aware extraction of the edge device characteristics. In one example, for each identified processing step, a target processing unit in the processor platform 416 may be identified based on computational complexity and/or type of data processing operations associated with the identified processing step and the computational capability (for example, speed, power, and/or accuracy) of the target processing units in the edge device 104.

Referring again to the example of the super-resolution task, if the processing step entails upscaling, the CPU 418 in the processor platform 416 may be identified as the most suitable target processing unit based on the edge device aware extraction of the edge device characteristics and/or the model 412. Accordingly, the input multimedia content 402 may be communicated to the CPU 418 for optimal processing. In a similar fashion, if the processing step entails video characterization of the input multimedia content 402, the GPU 420 may be identified as the most suitable target processing unit based on the processing power of the edge device 104 encoded in the edge device characteristics of the context characteristics and/or the model 412. Hence, use of the edge device characteristics in the form of the context characteristics and the model 412 enables optimization of resource utilization, which in turn minimizes consumption of additional power for the context driven processing by the edge device 104 to facilitate low power operation of the edge device 104.

Subsequent to the identification of the suitable target processing units in the processor platform 416, each processing step is then executed on the identified target processing unit to generate an output that includes multimedia content with enhanced quality and/or information content. In particular, the incoming input multimedia content 402 is processed by the identified target processing units to perform the processing steps based on the context characteristics and/or the model/model metadata 412. Consequent to this processing by the CDMP system 106 and the context aware AI platform 408 in particular, an improved output multimedia content is generated. In certain embodiments, the improved output multimedia content may include output that has enhanced visual quality, enhanced aural quality, enhanced information content, and the like. Referring again to the super-resolution task, the improved output multimedia content may include output that has “super-resolved” multimedia content having a higher pixel density and more details.

With continuing reference to FIG. 4, the edge device 104 may include an interface unit, which in turn includes a display 428 and a user interface 430. The display 428 and the user interface 430 may overlap in some embodiments such as a touch screen. Further, in some embodiments, the display 428 and the user interface 430 may include a common area.

The improved output multimedia content so generated by the context aware AI platform 408 may then be provided via the interface unit. In one example, the improved output multimedia content may be visualized on the display 428 of the edge device 104. In accordance with aspects of the present specification, the improved output multimedia content may be visualized on the display 428 by dynamically reconfiguring the display 428 to receive and visualize the improved output multimedia content. In one embodiment, a rendering unit 434 may be used to dynamically reconfigure the display 428 to visualize the improved output multimedia content. By way of a non-limiting example, the rendering unit 434 may be configured to facilitate the dynamic display reconfiguration of the display 428 between the low quality input multimedia content 402 and the improved output multimedia content generated by the context aware AI platform 408.

Moreover, in one embodiment, the user interface 430 of the edge device 104 may include a human interface device (not shown) that is configured to aid the user in providing inputs or manipulating the multimedia content visualized on the display 428. In certain embodiments, the human interface device may include a trackball, a joystick, a stylus, a mouse, or a touch screen. It may be noted that the user interface 430 may be configured to aid the user 102 in navigating through the inputs provided to the CDMP system 106 and/or outputs generated by the CDMP system 106.

Implementing the CDMP system 106 on the edge device 104, where the CDMP system 106 includes the context aware AI platform 408 as described hereinabove aids in enhancing the performance of the edge device 104 by providing an enriched streaming of the multimedia content in real-time, while obviating the dependency on network bandwidth availability and reducing transmission cost. Additionally, use of the CDMP system 106 on the edge device 104 provides real-time AI-based enhancement of the quality of the input multimedia content 402 on the edge device 104. Also, use of the context characteristics facilitates “context aware” abstraction for intelligent processing of the input multimedia content 402 in real-time on the edge device 104, thereby achieving superior quality in real-time. Moreover, the context aware capability provided by the CDMP system 106 aids in optimizing system level workflow. Also, use of the context characteristics provides “edge device aware” processing of the input multimedia content 402, thereby allowing optimization of power consumed by the edge device 104. In particular, performing context driven processing of the input multimedia content 402 results in a low power consumption of the edge device 104. Specifically, performing the context driven processing of the input multimedia content on the edge device 104 results in an additional consumption of less than 1% power in comparison to power consumption of the edge device 104 when the context driven processing is not performed.

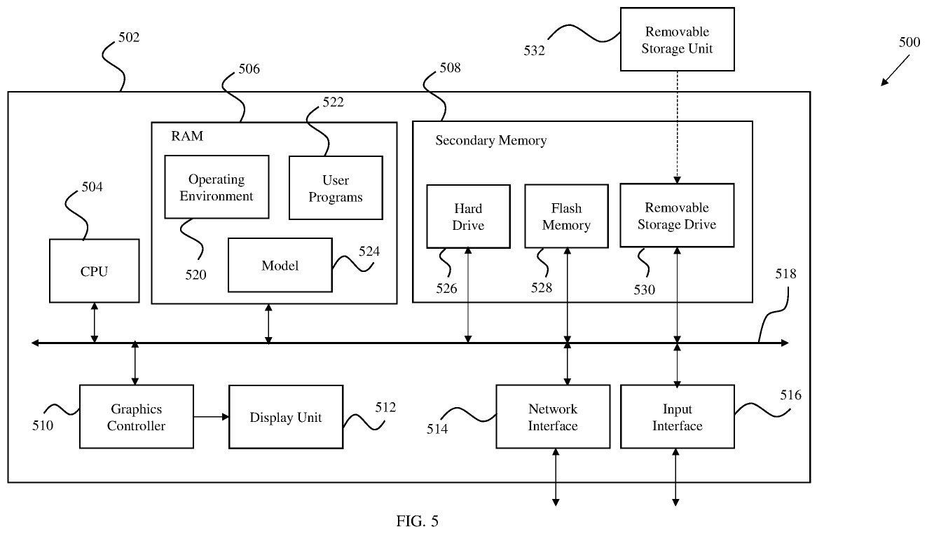

Turning now to FIG. 5, a schematic representation 500 of one embodiment 502 of a digital processing system implementing the CDMP system 106 (see FIGS. 1 and 4), in accordance with aspects of the present specification, is depicted. Also, FIG. 5 is described with reference to the components of FIGS. 1-4.

It may be noted that while the CDMP system 106 is shown as being a part of the edge device 104, in certain embodiments, the CDMP system 106 may also be integrated into other end user systems. Moreover, the example of the digital processing system 502 presented in FIG. 5 is for illustrative purposes. Other designs are also anticipated.

The digital processing system 502 may contain one or more processors such as a central processing unit (CPU) 504, a random access memory (RAM) 506, a secondary memory 508, a graphics controller 510, a display unit 512, a network interface 514, and an input interface 516. It may be noted that the components of the digital processing system 502 except the display unit 512 may communicate with each other over a communication path 518. In certain embodiments, the communication path 518 may include several buses, as is well known in the relevant arts.

The CPU 504 may execute instructions stored in the RAM 506 to provide several features of the present specification. Moreover, the CPU 504 may include multiple processing units, with each processing unit potentially being designed for a specific task. Alternatively, the CPU 504 may include only a single general-purpose processing unit.

Furthermore, the RAM 506 may receive instructions from the secondary memory 508 using the communication path 518. Also, in the embodiment of FIG. 5, the RAM 506 is shown as including software instructions constituting a shared operating environment 520 and/or other user programs 522 (such as other applications, DBMS, and the like). In addition to the shared operating environment 520, the RAM 506 may also include other software programs such as device drivers, virtual machines, and the like, which provide a (common) run time environment for execution of other/user programs. Moreover, in certain embodiments, the RAM 506 may also include a model 524. The model 524 may be the models 412 (see FIG. 4), 324 (see FIG. 3).

With continuing reference to FIG. 5, the graphics controller 510 is configured to generate display signals (e.g., in RGB format) for display on the display unit 512 based on data/instructions received from the CPU 504. The display unit 512 may include a display screen to display images defined by the display signals. Furthermore, the input interface 516 may correspond to a keyboard and a pointing device (e.g., a touchpad, a mouse, and the like) and may be used to provide inputs. In addition, the network interface 514 may be configured to provide connectivity to a network (e.g., using Internet Protocol), and may be used to communicate with other systems connected to a network, for example.

Moreover, the secondary memory 508 may include a hard drive 526, a flash memory 528, and a removable storage drive 530. The secondary memory 508 may store data generated by the system 100 (see FIG. 1) and software instructions (for example, for implementing the various features of the present specification), which enable the digital processing system 502 to provide several features in accordance with the present specification. The code/instructions stored in the secondary memory 508 may either be copied to the RAM 506 prior to execution by the CPU 504 for higher execution speeds or may be directly executed by the CPU 504.

Some or all of the data and/or instructions may be provided on a removable storage unit 532, and the data and/or instructions may be read and provided by the removable storage drive 530 to the CPU 504. Further, the removable storage unit 532 may be implemented using medium and storage format compatible with the removable storage drive 530 such that the removable storage drive 530 can read the data and/or instructions. Thus, the removable storage unit 532 includes a computer readable (storage) medium having stored therein computer software and/or data. However, the computer (or machine, in general) readable medium can also be in other forms (e.g., non-removable, random access, and the like.).

It may be noted that as used herein, the term “computer program product” is used to generally refer to the removable storage unit 532 or a hard disk installed in the hard drive 526. These computer program products are means for providing software to the digital processing system 502. The CPU 504 may retrieve the software instructions and execute the instructions to provide various features of the present specification.

Also, the term “storage media/medium” as used herein refers to any non-transitory media that store data and/or instructions that cause a machine to operate in a specific fashion. Such storage media may include non-volatile media and/or volatile media. Non-volatile media include, for example, optical disks, magnetic disks, or solid-state drives, such as the secondary memory 508. Volatile media include dynamic memory, such as the RAM 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, the transmission media may include coaxial cables, copper wire, and fiber optics, including the wires that include the communication path 518. Moreover, the transmission media can also take the form of acoustic or light waves, such as those generated during radio-wave and infra-red data communications.

Reference throughout this specification to “one embodiment,” “an embodiment,” or similar language means that a particular feature, structure, or characteristic described in connection with the embodiment is included in at least one embodiment of the present specification. Thus, appearances of the phrases “in one embodiment,” “in an embodiment” and similar language throughout this specification may, but do not necessarily, all refer to the same embodiment.

Furthermore, the described features, structures, or characteristics of the specification may be combined in any suitable manner in one or more embodiments. In the description presented hereinabove, numerous specific details are provided such as examples of programming, software modules, user selections, network transactions, database queries, database structures, hardware modules, hardware circuits, hardware chips, and the like, to provide a thorough understanding of embodiments of the specification.

The aforementioned components may be dedicated hardware elements such as circuit boards with digital signal processors or may be software running on a general-purpose computer or processor such as a commercial, off-the-shelf personal computer (PC). The various components may be combined or separated according to various embodiments of the invention.

Furthermore, the foregoing examples, demonstrations, and process steps such as those that may be performed by the system may be implemented by suitable code on a processor-based system, such as a general-purpose or special-purpose computer. It should also be noted that different implementations of the present specification may perform some or all of the steps described herein in different orders or substantially concurrently, that is, in parallel. Furthermore, the functions may be implemented in a variety of programming languages, including but not limited to C++, Python, and Java. Such code may be stored or adapted for storage on one or more tangible, machine readable media, such as on data repository chips, local or remote hard disks, optical disks (that is, CDs or DVDs), memory or other media, which may be accessed by a processor-based system to execute the stored code. Note that the tangible media may include paper or another suitable medium upon which the instructions are printed. For instance, the instructions may be electronically captured via optical scanning of the paper or other medium, then compiled, interpreted, or otherwise processed in a suitable manner if necessary, and then stored in the data repository or memory.

Embodiments of the systems and methods for context driven processing of multimedia content on an edge device described hereinabove advantageously present a robust framework for enhancing the performance of the edge device by providing an enriched streaming of the multimedia content in real-time, while obviating the dependency on network bandwidth availability and reducing transmission cost. Additionally, use of the CDMP system on the edge device provides real-time AI-based enhancement of the quality of the input multimedia content on the edge device. Also, use of the context characteristics facilitates “context aware” abstraction for intelligent processing of the input multimedia content, thereby achieving superior quality in real-time.

Furthermore, use of the edge device aware extraction of the edge device characteristics in the form of the context characteristics enables optimization of resource utilization, while minimizing consumption of additional power by the edge device, thereby maximizing quality of experience for the user. In addition, employing user characteristics and the edge device characteristics aids in optimizing system level workflow. Also, use of the multimedia characteristics enables optimized AI processing of the multimedia content. Further, the dynamic selection of the model promotes optimization of the processing speed and quality based on the input multimedia content, the edge device, and the user, thereby providing significant improvement in quality of experience for end users. Moreover, use of the CDMP system results in significant reduction in transcoding, storage, and transmission costs for streaming service providers. In addition, use of the CDMP system also enables significant reduction in data consumption costs for end consumers. Also, the edge device having the exemplary CDMP system provides a solution to the issue of multimedia streaming that is agnostic of existing infrastructure. These systems and methods also find application in areas related to multimedia storage, transmission, consumption, and multiplexed communication.

Although specific features of embodiments of the present specification may be shown in and/or described with respect to some drawings and not in others, this is for convenience only. It is to be understood that the described features, structures, and/or characteristics may be combined and/or used interchangeably in any suitable manner in the various embodiments.

While only certain features of the present specification have been illustrated and described herein, many modifications and changes will occur to those skilled in the art. It is, therefore, to be understood that the present specification is intended to cover all such modifications and changes as fall within the true spirit of the invention.

1. A system (100) for context driven processing of multimedia content on an edge device (104), the system (100) comprising:
an acquisition subsystem (404) configured to obtain input multimedia content (402);
a processing subsystem (406) in operative association with the acquisition subsystem (404) and comprising a context aware artificial intelligence platform (408), wherein the context aware artificial intelligence platform (408) is, on the edge device (104), configured to:
generate context characteristics based on user characteristics, edge device characteristics, multimedia characteristics, or combinations thereof;
retrieve at least one model (324, 412) based on the context characteristics;
identify one or more processing steps based on the at least one model (324, 412), the context characteristics, or both the at least one model (324, 412) and the context characteristics, wherein the one or more processing steps are used to perform context driven processing of the input multimedia content (402) on the edge device (104);
select, based on the at least one model (324, 412), the context characteristics, or both the at least one model (324, 412) and the context characteristics, one or more target processing units (418, 420, 422, 424, 426) to perform the one or more processing steps;
execute the one or more processing steps on the selected one or more target processing units (418, 420, 422, 424, 426) to generate improved output multimedia content, wherein the improved output multimedia content comprises enhanced visual quality, enhanced aural quality, enhanced information content, or combinations thereof; and
an interface unit (428, 430) configured to provide, on the edge device (104), the improved output multimedia content.

2. The system (100) of claim 1, wherein the context aware artificial intelligence platform (108) is configured to perform the context driven processing of the input multimedia content (402) in real-time, on the edge device.

3. The system (100) of claim 2, wherein the context aware artificial intelligence platform (108) is configured to facilitate a low power consumption of the edge device (104) performing the context driven processing of the input multimedia content (402) in real-time.

4. The system (100) of claim 1, wherein the context aware artificial intelligence platform (108) is further configured to:
receive user characteristics corresponding to a user (102) of the edge device (104);
receive edge device characteristics corresponding to the edge device (104); and
extract multimedia characteristics from the input multimedia content (402).

5. The system (100) of claim 4, wherein to generate the context characteristics, the context aware artificial intelligence platform (108) is configured to:
extract context-based features, contextual information, content information, or combinations thereof and corresponding relationships therebetween from one or more of the user characteristics, the edge device characteristics, and the multimedia characteristics; and
create the context characteristics based on the extracted context-based features, the contextual information, the content information, and the corresponding relationships,
wherein the context characteristics are created in real-time on the edge device (104), and wherein the context characteristics are employed to enhance one or more of visual quality, aural quality, and information content of the input multimedia content (402) in real-time on the edge device.

6. The system (100) of claim 1, wherein to retrieve the at least one model (324, 412), the context aware artificial intelligence platform (108) is configured to dynamically identify a model (324, 412) that is optimized for processing the input multimedia content (402) based on the context characteristics.

7. The system (100) of claim 6, wherein to dynamically identify the model (324, 412), the context aware artificial intelligence platform (108) is configured to:
perform content aware extraction of the multimedia characteristics from the context characteristics;
perform edge device aware extraction of the edge device characteristics from the context characteristics; and
select a model (324, 412) that is most suited to perform a task to process the input multimedia content (402) based at least on content aware extraction of the multimedia characteristics and the edge device aware extraction of the edge device characteristics.

8. The system (100) of claim 1, wherein the context aware artificial intelligence platform (108) is further configured to generate one or more models (324, 412), and wherein the one or more models (324, 412) are tuned for performing one or more tasks.

9. The system (100) of claim 8, wherein to generate the one or more models (324, 412), the context aware artificial intelligence platform (108) is configured to:
receive an input corresponding to the one or more tasks to be performed;
obtain a plurality of multimedia datasets of known visual quality, known aural quality, known information content, or combinations thereof;
obtain a plurality of multimedia datasets of known higher visual quality, known higher aural quality, known higher information content, or combinations thereof;
generate one or more training multimedia dataset pairs, wherein each training multimedia dataset pair comprises an input multimedia dataset from the plurality of multimedia datasets of known visual quality, known aural quality, known information content, or combinations thereof and a corresponding output multimedia dataset from the plurality of multimedia datasets of known higher visual quality, known higher aural quality, known higher information content, or combinations thereof; and
receive a plurality of visual metrics based on the one or more training multimedia dataset pairs and the one or more tasks to be performed.

10. The system (100) of claim 9, wherein the context aware artificial intelligence platform (108) is further configured to:
receive edge device characteristics corresponding to one or more edge devices (104);
receive user characteristics corresponding to one or more users (102);
extract multimedia characteristics from the one or more training multimedia dataset pairs; and
generate context characteristics based on the edge device characteristics corresponding to one or more edge devices (104), the user characteristics corresponding to one or more users (102), the multimedia characteristics corresponding to the one or more training multimedia dataset pairs, or combinations thereof.

11. The system (100) of claim 10, wherein the context aware artificial intelligence platform (108) is configured to:
select one or more training processes based on the context characteristics, the one or more training multimedia dataset pairs, and the plurality of visual metrics; and
train a neural network using the one or more training processes to generate a model (324, 412), model metadata, or a combination thereof, wherein the model (324, 412) and the model metadata are configured to perform the one or more tasks.

12. The system (100) of claim 1, wherein to identify the one or more processing steps, the context aware artificial intelligence platform (108) is configured to:
perform content aware extraction of the multimedia characteristics from the context characteristics, and
select one or more processing steps to process the input multimedia content (402) based at least on the content aware extraction of the multimedia characteristics.

13. The system (100) of claim 1, wherein to select the one or more target processing units (418, 420, 422, 424, 426), the context aware artificial intelligence platform (108) is configured to:
perform edge device aware extraction of the edge device characteristics from the context characteristics; and
for each processing step, identify one or target processing units (418, 420, 422, 424, 426) that are optimized to perform that processing step based at least on the edge device aware extraction of the edge device characteristics.

14. A method (200) for context driven processing of multimedia content on an edge device, the method comprising:
(a) receiving (204) input multimedia content (402);
(b) generating (212) context characteristics based on user characteristics, edge device characteristics, multimedia characteristics, or combinations thereof;
(c) retrieving (214) at least one model (324, 412) based on the context characteristics;
(d) identifying (216) one or more processing steps based on the at least one model (324, 412), the context characteristics, or both the at least one model (324, 412) and the context characteristics, wherein the one or more processing steps are used to perform context driven processing of the input multimedia content (402) on the edge device (104);
(e) selecting (218), based on the at least one model (324, 412), the context characteristics, or both the at least one model (324, 412) and the context characteristics, one or more target processing units (418, 420, 422, 424, 426) to perform the one or more processing steps;
(f) executing (220) the one or more processing steps on the selected one or more target processing units (418, 420, 422, 424, 426) to generate improved output multimedia content, wherein the improved output multimedia content comprises enhanced visual quality, enhanced aural quality, enhanced information content, or combinations thereof; and
(g) providing (222) the improved output multimedia content.

15. The method (200) of claim 14, wherein steps (a)-(g) are performed in real-time on the edge device (104).

16. The method (200) of claim 14, wherein generating the context characteristics comprises:
receiving (208) user characteristics corresponding to a user (102) of the edge device (104);
receiving (206) edge device characteristics corresponding to the edge device (104);
extracting (210) multimedia characteristics from the input multimedia content (402);
extracting context-based features, contextual information, content information, or combinations thereof and corresponding relationships therebetween from one or more of the user characteristics, the edge device characteristics, and the multimedia characteristics; and
creating (212) the context characteristics using the extracted context-based features, the contextual information, the content information, and the corresponding relationships,
wherein the context characteristics are created in real-time on the edge device (104), and wherein the context characteristics are employed to enhance one or more of visual quality, aural quality, and information content of the input multimedia content (402) in real-time.

17. The method (200) of claim 14, wherein retrieving at least one model (324, 412) comprises dynamically identifying a model (324, 412) that is optimized for processing the input multimedia content (402) based on the context characteristics.

18. The method (200) of claim 17, wherein dynamically identifying the model comprises:
performing content aware extraction of the multimedia characteristics from the context characteristics;
performing edge device aware extraction of the edge device characteristics from the context characteristics; and
selecting a model (324, 412) that is most suited to perform a task to process the input multimedia content (402) based at least on content aware extraction of the multimedia characteristics and the edge device aware extraction of the edge device characteristics.

19. The method (200) of claim 14, further comprising generating one or more models (324, 412), and wherein the one or more models (324, 412) are tuned for performing one or more tasks.

20. The method (200) of claim 19, wherein generating the one or more models (324, 412) comprises:
receiving (302) an input corresponding to the one or more tasks to be performed;
obtaining (304) a plurality of multimedia datasets of known visual quality, known aural quality, known information content, or combinations thereof;
obtaining (306) a plurality of multimedia datasets of known higher visual quality, known higher aural quality, known higher information content, or combinations thereof;
generating (308) one or more training multimedia dataset pairs, wherein each training multimedia dataset pair comprises an input multimedia dataset and a corresponding output multimedia dataset; and
receiving (310) a plurality of visual metrics based on the one or more training multimedia dataset pairs and the one or more tasks to be performed.

21. The method (200) of claim 20, further comprising:
receiving (312) edge device characteristics corresponding to one or more edge devices (104);
receiving (314) user characteristics corresponding to one or more users (102);
extracting (316) multimedia characteristics from the one or more training multimedia dataset pairs; and
generating (318) context characteristics based on the edge device characteristics corresponding to one or more edge devices (104), the user characteristics corresponding to one or more users (102), the multimedia characteristics corresponding to the one or more training multimedia dataset pairs, or combinations thereof.

22. The method (200) of claim 21, further comprising selecting (320) one or more training processes based on the context characteristics, the one or more training multimedia dataset pairs, and the plurality of visual metrics.

23. The method (200) of claim 22, further comprising training (322) a neural network using the one or more training processes to generate a model (324, 412), model metadata, or a combination thereof, wherein the model (324, 412) and the model metadata are configured to perform the one or more tasks.

24. The method (200) of claim 14, wherein identifying (216) the one or more processing steps comprises:
performing content aware extraction of the multimedia characteristics from the context characteristics, and
selecting one or more processing steps to process the input multimedia content (402) based at least on the content aware extraction of the multimedia characteristics.

25. The method (200) of claim 14, wherein selecting (218) the one or more target processing units comprises:
performing edge device aware extraction of the edge device characteristics from the context characteristics; and
for each processing step, identifying one or target processing units (418, 420, 422, 424, 426) that are optimized to perform that processing step based at least on the edge device aware extraction of the edge device characteristics.

26. A processing system (106) for context driven processing of multimedia content on an edge device (104), the processing system (106) comprising:
a context aware artificial intelligence platform (108), wherein the context aware artificial intelligence platform (108) is, in real-time on the edge device (104), configured to:
generate context characteristics based on user characteristics, edge device characteristics, multimedia characteristics, or combinations thereof;
retrieve at least one model (324, 412) based on the context characteristics;
identify one or more processing steps based on the at least one model (324, 412), the context characteristics, or both the at least one model (324, 412) and the context characteristics, wherein the one or more processing steps are used to perform context driven processing of the input multimedia content (402) on the edge device (104);
select, based on the at least one model (324, 412), the context characteristics, or both the at least one model (324, 412) and the context characteristics, one or more target processing units (418, 420, 422, 424, 426) to perform the one or more processing steps;
execute the one or more processing steps on the selected one or more target processing units (418, 420, 422, 424, 426) to generate improved output multimedia content, wherein the improved output multimedia content comprises enhanced visual quality, enhanced aural quality, enhanced information content, or combinations thereof; and
provide the improved output multimedia content,
wherein the context driven processing of the multimedia content in performed in real-time, on the edge device (104).

27. A non-transitory computer readable medium that stores instructions executable by one or more processors to perform a method for context driven processing of multimedia content (402) on an edge device (104), comprising:
(a) receiving (204) multimedia content (402);
(b) generating (212) context characteristics based on user characteristics, edge device characteristics, multimedia characteristics, or combinations thereof;
(c) retrieving (214) at least one model (324, 412) based on the context characteristics;
(d) identifying (216) one or more processing steps based on the at least one model (324, 412), the context characteristics, or both the at least one model (324, 412) and the context characteristics, wherein the one or more processing steps are used to perform real-time context driven processing of the input multimedia content (402) on the edge device (104);
(e) selecting (218), based on the at least one model (324, 412), the context characteristics, or both the at least one model (324, 412) and the context characteristics, one or more target processing units (418, 420, 422, 424, 426) to perform the one or more processing steps;
(f) executing (220) the one or more processing steps on the selected one or more target processing units (418, 420, 422, 424, 426) to generate improved output multimedia content, wherein the improved output multimedia content comprises enhanced visual quality, enhanced aural quality, enhanced information content, or combinations thereof; and
(g) providing (222) the improved output multimedia content,
wherein steps (a)-(g) are performed in real-time on the edge device (104).
